(19) United States
(12) Patent Application Publication
(10) Pub. No.: US 2013/0283983 A1
(43) Pub. Date: Oct. 31, 2013

(54) Ratchet Wrench

(71) Applicant: Lowell Corporation, West Boylston, MA (US)

(72) Inventors: David S. Cummings, Princeton, MA (US); Derek Silsby, Worcester, MA (US); Paul Carnes, North Dartmouth, MA (US)

(21) Appl. No.: 13/855,468

(22) Filed: Apr. 2, 2013

Related U.S. Application Data
(60) Provisional application No. 61/619,088, filed on Apr. 2, 2012.
(60) Provisional application No. 61/695,146, filed on Aug. 30, 2012.

(51) Int. Cl. B25B 13/46

(52) U.S. Cl. CPC B25B 13/463
USPC 81/63.2

(57) ABSTRACT

A ratchet wrench is configured as a double-ended and reversible bolt-through wrench configured to actuate four different fastener sizes. The wrench can include socket hubs that can be provided in high-visibility colors to provide easy identification by the user. The socket hubs can include extension portions which extend beyond the respective faces of the handle to provide adequate contact between the socket hubs and a target fastener. Each socket hub includes a corresponding rotational direction controller or shifter that allows the socket hub to reverse it direction of rotational actuation relative to a fastener.

### RELATED APPLICATIONS

This patent application claims the benefit of U.S. Provisional Application No. 61/619,088, filed on Apr. 2, 2012, entitled, “Ratchet Wrench,” and claims the benefit of U.S. Provisional Application No. 61/695,146, filed on Aug. 30, 2012, entitled, “Ratchet Wrench,” the contents and teachings of each of which are hereby incorporated by reference in their entirety.

### BACKGROUND

A conventional ratchet wrench is configured to tighten or loosen fasteners, such as nuts or bolts, with a series of sequential backward and forward rotations. For example, a typical through bolt ratchet wrench can include a handle having opposing ratchet heads, with each ratchet head corresponding to a different size of fastener.

### SUMMARY

Conventional ratchet wrenches suffer from a variety of deficiencies. For example, conventional ratchet wrenches can be utilized with, at most, two differently sized fasteners. This requirement generally necessitates that a plurality of ratchet wrenches be available to a user at a job site. Furthermore, this wrench configuration requires that when a user encounters a differently sized fastener, the user must stop work to find the appropriate ratchet wrench corresponding to the size of the fastener.

By contrast to conventional ratchet wrenches, embodiments of the present innovation relate to a ratchet wrench for multiple fastener sizes. In one arrangement, the ratchet wrench is a double-ended and reversible bolt-through wrench configured to actuate four different fastener sizes. For example, the ratchet wrench can be configured with a length of at least 8 inches and can include socket hubs configured to accommodate, as a minimum head size, ¾ inches Hex. With such a configuration, the ratchet wrench provides a user with an increased toque capability and a decreased backlash, relative to conventional torque wrenches. In one arrangement the socket hubs are provided in high-visibility colors to provide easy identification by the user. The socket hubs can include extension portions which extend beyond the respective faces of the handle to provide adequate contact between the socket hubs and a target fastener. Each socket hub includes a corresponding rotational direction controller or shifter that allows the socket hub to reverse it direction of rotational actuation relative to a fastener.

In one arrangement, a ratchet wrench includes a handle and a first socket hub disposed at a first end of the handle, the first socket hub configured to actuate one of a first-sized fastener and a second-sized fastener and the first socket hub having a set of internal teeth disposed about an outer periphery of the first socket hub, the outer tooth diameter of each of the internal teeth is configured as being less than or equal to an outside diameter of the first socket hub. The ratchet wrench has a second socket hub disposed at a second end of the handle, the second end opposing the first end, the second socket hub configured to actuate one of a third-sized fastener and a fourth-sized fastener and the second socket hub having a set of internal teeth disposed about an outer periphery of the second socket hub, the outer tooth diameter of each of the internal teeth is configured as being less than or equal to an outside diameter of the second socket hub. The ratchet wrench includes a first rotational direction controller having a pawl and spring mechanism, the pawl of the first rotational direction controller configured to engage at least one of the internal teeth of the first socket hub, the first rotational direction controller configured to allow one of clockwise and counterclockwise ratcheting of the first socket hub relative to the handle and a second rotational direction controller having a pawl and spring mechanism, the pawl of the second rotational direction controller configured to engage at least one of the internal teeth of the second socket hub, the second rotational direction controller configured to allow one of clockwise and counterclockwise ratcheting of the second socket hub relative to the handle.

In one arrangement, a ratchet wrench includes a handle, a first socket hub disposed at a first end of the handle, the first socket hub configured to actuate one of a first-sized fastener and a second-sized fastener and the first socket hub having a set of teeth disposed about an outer periphery of the first socket hub, and a second socket hub disposed at a second end of the handle, the second end opposing the first end, the second socket hub configured to actuate one of a third-sized fastener and a fourth-sized fastener and the second socket hub having a set of teeth disposed about an outer periphery of the second socket hub. The ratchet wrench has a first rotational direction controller having a pawl and spring mechanism, the pawl of the first rotational direction controller being configured with at least two teeth to engage at least three teeth of the set of teeth of the first socket hub, the first rotational direction controller configured to allow one of clockwise and counterclockwise ratcheting of the first socket hub relative to the handle and a second rotational direction controller having a pawl and spring mechanism, the pawl of the second rotational direction controller being configured with at least two teeth to engage at least three teeth of the set of teeth of the second socket hub, the second rotational direction controller configured to allow one of clockwise and counterclockwise ratcheting of the second socket hub relative to the handle.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1A illustrates a perspective view of a ratchet wrench, according to one arrangement.

FIG. 1B illustrates a perspective view of a set of mechanical components associated with the ratchet wrench of FIG. 1A, according to one arrangement.

FIG. 1C illustrates a perspective view of a ratchet wrench having a sheath disposed on the handle, according to one arrangement.

FIG. 2 illustrates a front view of a ratchet wrench, according to one arrangement.

FIG. 3 illustrates a sectional top view of the ratchet wrench of FIG. 2, according to one arrangement.

FIG. 4 illustrates a sectional rear view of the ratchet wrench of FIG. 3 taken along section A-A, according to one arrangement.

FIG. 5 illustrates a perspective sectional view of a socket hub having internal teeth, according to one arrangement.

FIG. 6 illustrates a pawl as used in the ratchet wrench of FIG. 2, according to one arrangement.

FIG. 7 illustrates a pawl as used in the ratchet wrench of FIG. 2, according to one arrangement.

FIG. 8 illustrates a pawl as used in the ratchet wrench of FIG. 2, according to one arrangement.

FIG. 9 illustrates a pawl as used in the ratchet wrench of FIG. 2, according to one arrangement.

FIG. 10 illustrates a ratchet wrench, according to one arrangement.

FIG. 11 illustrates a pawl as used in the ratchet wrench of FIG. 10, according to one arrangement.

FIG. 12 illustrates the pawl of FIG. 11 engaging a socket hub, according to one arrangement.

FIG. 13 illustrates a perspective view of a socket hub having external teeth, according to one arrangement.

FIG. 14 illustrates a sectional view of a ratchet wrench having the socket hub of FIG. 13, according to one arrangement.

### DETAILED DESCRIPTION

Embodiments of the present innovation relate to a ratchet wrench for multiple fastener sizes. In one arrangement, the ratchet wrench is a double-ended and reversible bolt-through wrench configured to actuate four different fastener sizes. For example, the ratchet wrench can be configured with a length of at least 8 inches and can include socket hubs configured to accommodate, as a minimum head size, ¾ inches Hex. With such a configuration, the ratchet wrench provides a user with an increased toque capability and a decreased backlash, relative to conventional torque wrenches.

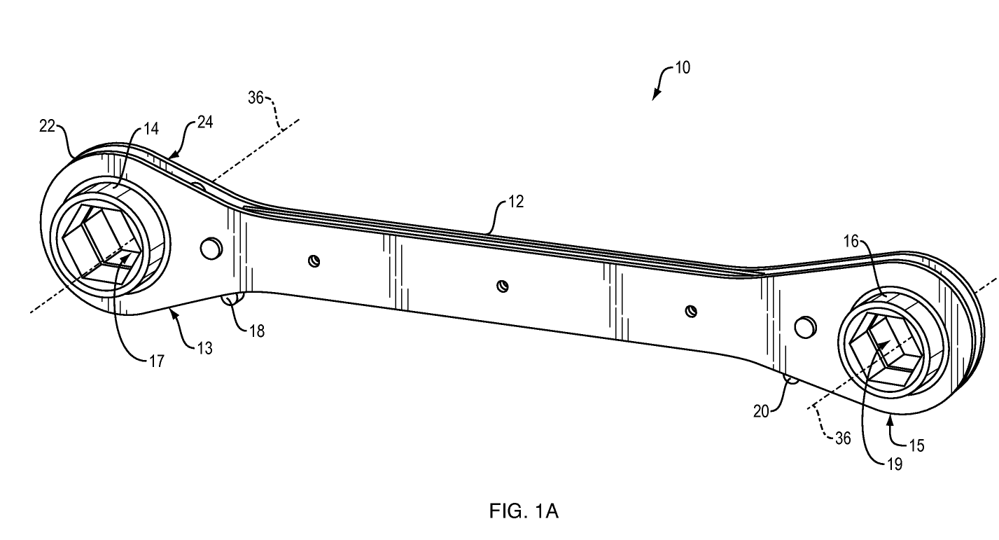

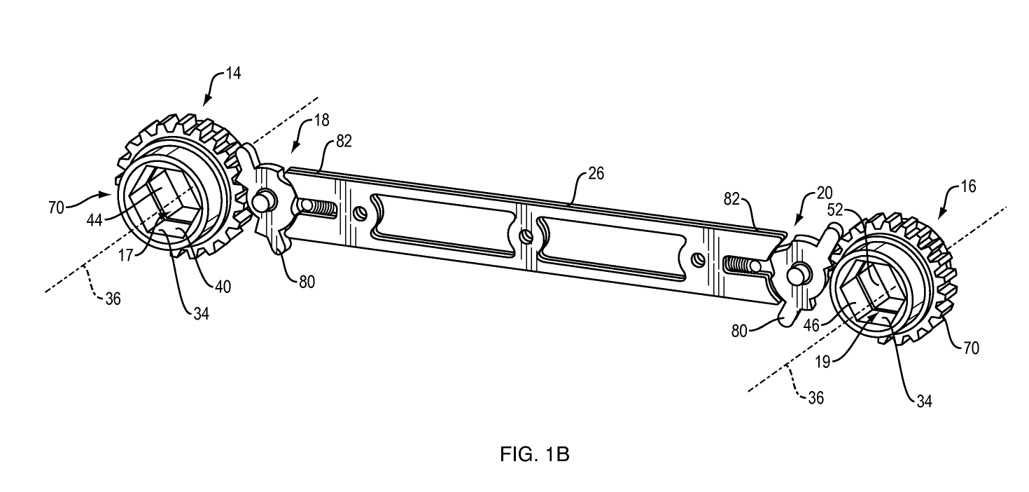

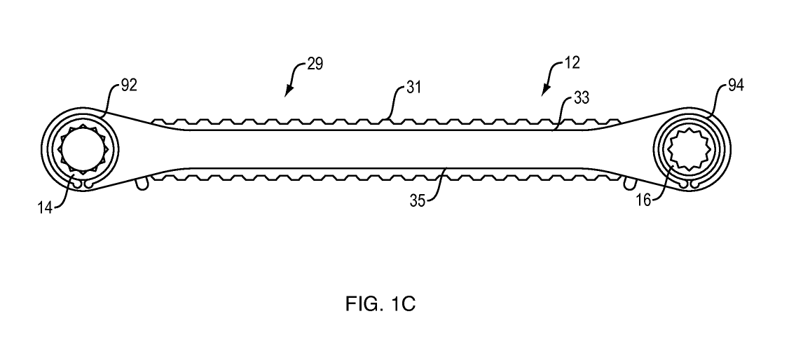

FIG. 1A illustrates a ratchet wrench 10, such as used in the water works industry, according to one arrangement. The ratchet wrench 10 includes a handle 12 having opposing handle ends 13, 15. Each handle end 13, 15 supports a corresponding socket hub 14, 16. As will be described in detail below, each socket hub 14, 16 interacts with a corresponding rotational direction controller or shifter 18, 20 to form a respective ratcheting mechanism.

With reference to FIGS. 1A and 1B, in one arrangement, the handle 12 includes a first plate 22, an opposing second plate 24, and a support member 26. The first and second plates 22, 24 are configured to capture and secure the first and second socket hubs 14, 16 and the first and second rotational direction controllers 18, 20 relative to the support member 26.

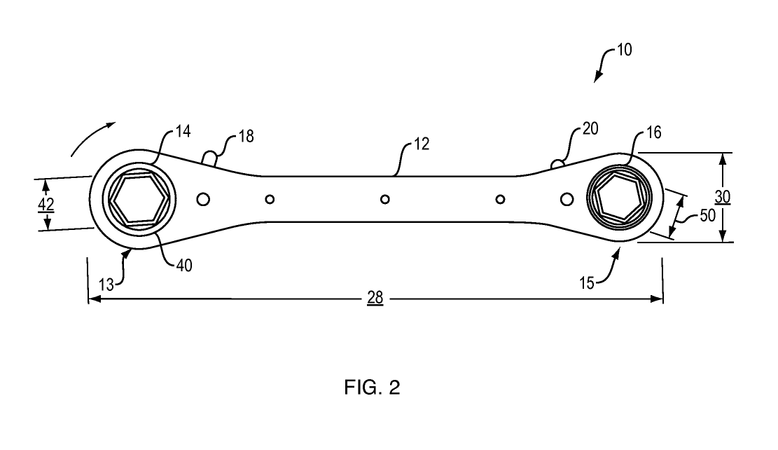

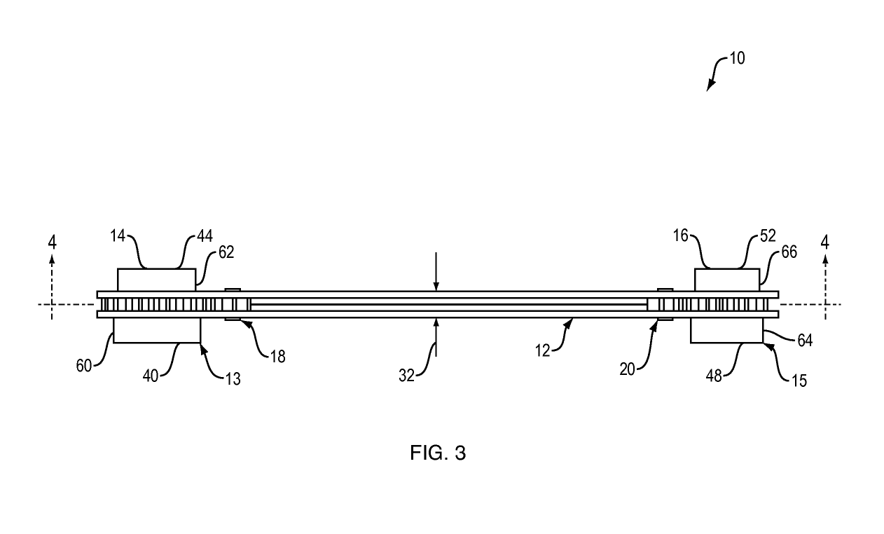

The handle 12 is configured to provide a level of durability to ratchet wrench 10. For example, in one arrangement and with reference to FIGS. 2 and 3, the handle 12 has a length 28 of greater than about 8 inches, a width 30 of between about 0.75 inches and 1.50 inches, and a thickness 32 of between about 0.5 inches and 1 inch. Additionally, the first and second plates 22, 24 as well as the support member can be stamped from an alloy steel material, such as a high strength alloy steel, to provide the level of durability to the ratchet wrench 10.

In one arrangement, with reference to FIG. 1C, the handle 12 can include a serrated gripping surface 26 extending along the length, of the handle 12. For example, the gripping surface 26 is configured as a molded element, such as manufactured from a plastic material, which defines a series of serrations or finger grip elements 31 disposed along a first portion 33 and a second portion 35 of the handle 12. With such a configuration, the gripping surface 26 covers the edges of the plates 22, 24 to minimize user discomfort during use. Additionally, the finger grip elements 31 provide the user with an ergonomic grasping surface to minimize slipping during use.

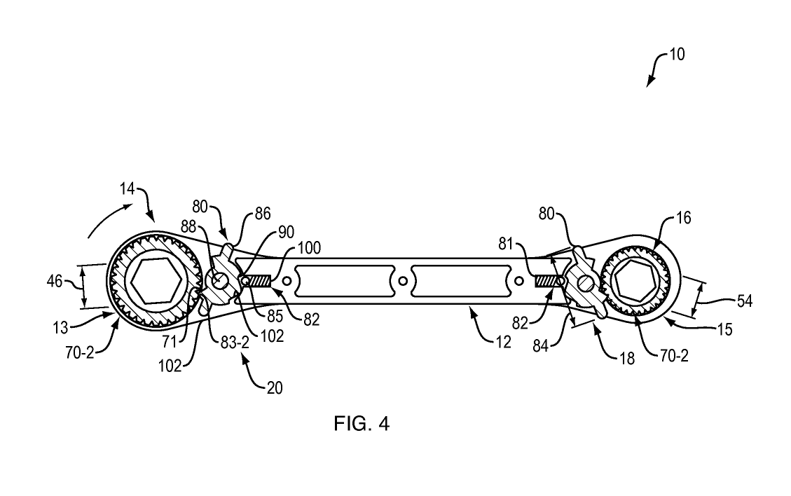

Each socket hub 14, 16 is also configured to provide a level of durability to the ratchet wrench 10. For example, in one arrangement and with reference to FIGS. 3 and 4, each socket hub 14, 16 can have a thickness 32 of between about 1 inch and 2.5 inches while each socket hub 14, 16 can have a hub diameters of between about 1.75 inches and 2.5 inches. Additionally, the first and second socket hub 14, 16 can be manufactured from an alloy steel material, such as a high strength alloy steel, to provide the level of durability to the ratchet wrench 10.

In one arrangement, the geometric and material configuration of the ratchet wrench 10 allows the wrench 10 to generate a relatively large amount of torque on a fastener during operation with a minimal amount of backlash. For example, the ratchet wrench 10 can generate a torque between about 150 ft-lb and 300 ft-lb.

With reference to FIGS. 1A and 1B, each socket hub 14, 16 is configured as a generally cylindrical structure having a set of fastener driving structures 34 disposed within an inner periphery of the socket hub 14, 16. While the fastener driving structures 34 can be configured in a variety of ways, in one arrangement, the fastener driving structures 34 are configured as hex drive structures having 6 point hexes or 12 point hexes, for example. The cylindrical structure of each socket hub 14, 16 defines a corresponding opening 17, 19 extending along a longitudinal axis 36 of the corresponding socket hub 14, 16 between a first end and a second end of the socket hub 14,16, thereby allowing for bolt-through capabilities of the ratchet wrench. For example, a socket hub 14, 16 can be disposed over a bolt shaft such that bolt shaft extends through the corresponding opening 17, 19 of the socket hub 14, 16 and along the hub's longitudinal axis 36.

With reference to FIGS. 2-4, each socket hub 14, 16 is configured to drive two differently sized fasteners. For example, the first socket hub 14 includes a first drive portion 40 (FIGS. 2 and 3) configured to drive a fastener, such as nut or bolt head, and having a first size 42 (FIG. 2) such as a size of 1.25 (1¼) Hex. The first socket hub 14 includes an opposing second drive portion 44 (FIGS. 3 and 4) configured to drive a fastener, such as nut or bolt head, having a second size 46 (FIG. 4) such as a size of 1.125 (1⅛) Hex. Additionally, the second socket hub 16 includes a first drive portion 48 (FIGS. 2 and 3) configured to drive a fastener, such as nut or bolt head, having a third size 50 (FIG. 2) such as a size of 1.063 (1 1/16) Hex. The second socket hub 16 includes an opposing second drive portion 52 (FIGS. 3 and 4) configured to drive a fastener, such as nut or bolt head, having a fourth size 54 (FIG. 4) such as a size of 0.938 inches ( 15/16) Hex. Accordingly, the ratchet wrench 10 provides a four-in-one fastener driving capability.

In one arrangement, each socket hub 14, 16 includes hub extension portions. For example, with reference to FIG. 3, the first socket hub 14 includes a first hub extension portion 60 extending from a first plate 22 of the handle 12 and second hub extension portion 62 extending from second plate 25 of the handle 12. Also, the second socket hub 16 includes a first hub extension portion 64 extending from the first plate 22 of the handle 12 and a second hub extension portion 66 extending from the second plate of the handle 12. Each hub extension portion 60, 62, 64, and 66 is disposed about respective drive portions 40, 44, 48, and 52, is substantially collinear with the longitudinal axes 36 of the corresponding socket hubs 14, 16. Accordingly, each hub extension portion 60, 62, 64, and 66 is configured to provide adequate contact between the respective socket hubs 14, 16 and a target fastener to minimize slipping between the ratchet wrench 10 and fastener during operation.

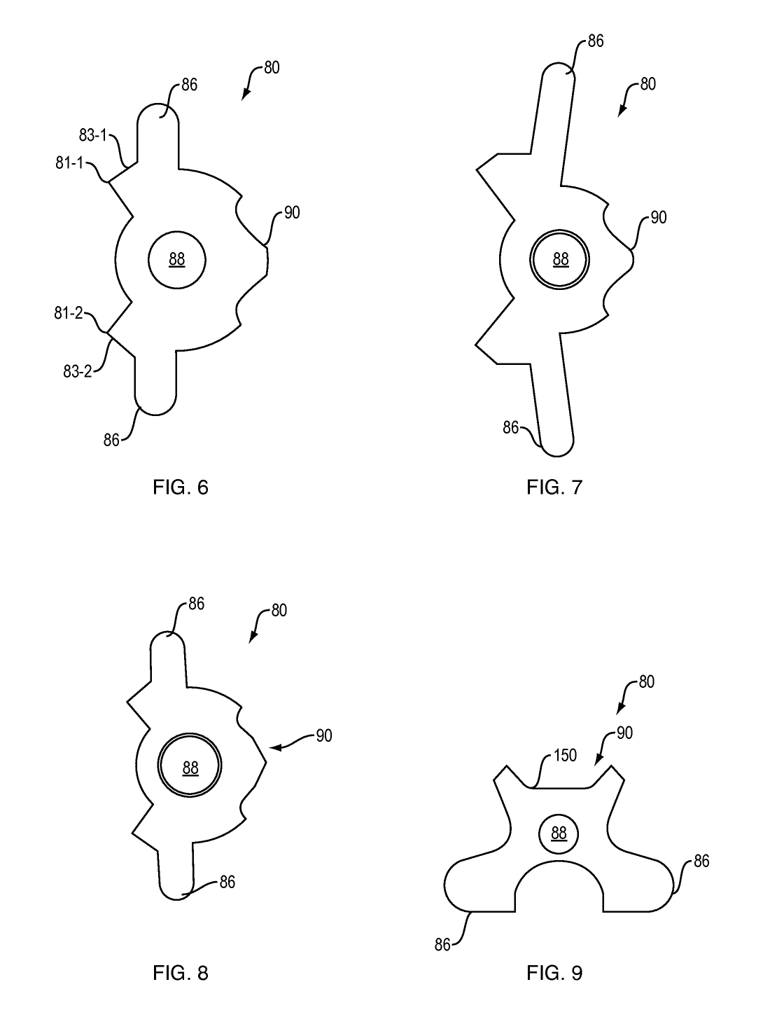

In one arrangement, the ratchet wrench 10 can also be configured such that either one or both of the socket hubs 14, 16 are removeably coupled to the handle 12. For example, with reference to FIG. 1C the first and second socket hubs 14, 16 are rotatably disposed in corresponding first and second openings defined by the handle 12. With reference to FIG. 6, each of the first and second socket hubs 14, 16 can define a groove portion 96 and a shoulder portion 98. Returning to FIG. 1C, the ratchet wrench 10 further includes fixation mechanisms 92, 94 that secure the corresponding socket hubs 14, 16 to the handle 12. For example, the fixation mechanisms 92, 94, such as snap rings, can be formed of a relatively flexible material.

In use after a user inserts the first and second socket hubs 14, 16 into the corresponding first and second openings defined by the handle 12, the user can dispose the fixation mechanisms 92, 94 within the corresponding grooves 96. Such an arrangement causes the fixation mechanisms 92, 96 and shoulder portions 98 of the corresponding first and second socket hubs 14, 16 to capture the handle 12 there between and rotatably secure the first and second socket hubs 14, 16 to the handle. The user can then deform the flexible fixation mechanisms 92, 94 manually to remove the fixation mechanisms 92, 94 from corresponding groove portions 96 of the socket hubs 14, 16 and remove the socket hubs 14, 16 from the first and second openings defined by the handle 12. Such a configuration allows the user to utilize the ratchet wrench 10 with socket hubs 14, 16 having differently sized drive portion based upon the size of a corresponding fastener to be actuated.

As indicated above, each socket hub 14, 16 forms part of a corresponding ratchet mechanism. For example, with reference to FIG. 1B, the socket 20 includes a set of teeth 70 disposed about an outer periphery of the cylinder structure. While the set of teeth 70 can include any number of teeth, in one arrangement, the set of teeth 70 include between about 20 teeth and 50 teeth to minimize backlash with the socket drive interface 22 during operation.

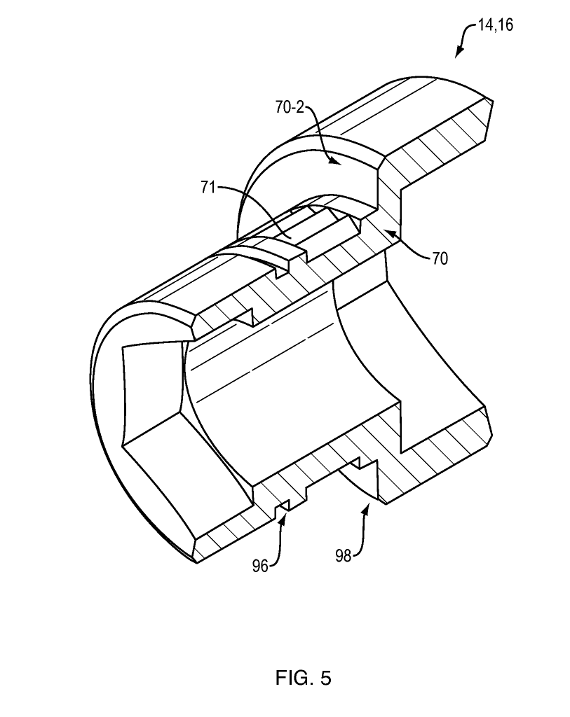

The teeth 70 can be configured in a variety of ways. For example, in the arrangement illustrated in FIGS. 4 and 5 the teeth 70 of each socket hub 14, 16 are configured as internal teeth 70-2. The internal teeth 70-2 are manufactured as part of the socket hub 20 where the outer tooth diameter of each of the internal teeth 70-2 is less than or equal to the outside diameters of the socket hubs 14, 16. In one arrangement, the outer diameter of the teeth 70 is equal to one outside end diameter of the socket housing 18. This allows a user to insert the socket 20 into an opening extending through the socket housing 18 and for the teeth 70 of the socket 20 to pass through the socket housing opening, thereby providing ease of assembly.

The teeth 70-2 of each socket hub 14, 16 are configured to interface with a corresponding rotational direction controller or shifter 18, 20. In one arrangement, with reference to FIGS. 2 and 4, each rotational direction controller 18, 20 includes a corresponding pawl 80 and spring mechanism 82, such as a ball 85 and a spring 87.

With reference to FIG. 4, the pawl 80 can have a length 84 extending between opposing actuators or levers 86 of between about 1.5 inches and 3.5 inches. The opposing levers or actuators 86 are configured to be activated by a user. Actuation of the actuators 86 causes the pawl 80 to pivot about an axel 88. The axel 88 can be configured as shaft that extends between first and second plates 22, 24 of the handle 12. While the axel 88 can be configured with a variety of diameters, in one arrangement, the axel diameter is between about 0.25 inches and 0.5 inches. The pawl 80 also includes a spring mechanism engagement portion 90 configured to interact with the spring mechanism 82 to allow rotation or driving of a socket hub in first direction and to limit rotation of socket hub in second, opposing direction, as will be described in detail below.

For example, as illustrated in FIGS. 4 and 6, the radius of curvature in the area where the spring mechanism engagement portion 90 meets the ball 85 is between about 0.25 inches and 0.5 inches. As shown, the pawl 80 is configured to rotate with the sliding ball 85 and spring 87. Alternate embodiments of the pawl 80 are illustrated in FIGS. 7-9. The alternate embodiments can include the pawl 80 being configured to slide along with the ball 85 and spring 87, as in having the pawl 80 slide perpendicularly to the ball 85 of the spring, and can include both the pawl 80 and the ball 85 and spring 87 rotating for engagement. In one arrangement, as illustrated in FIG. 9, a portion 150 of the spring mechanism engagement portion 90 is flat. The radius and/or flats of the spring mechanism engagement portion 90 allow the rotational direction controller 18, 20 to operate effectively to minimize or prevent the pawl 80 from popping out of engagement or from binding.

Additionally, the geometry of the pawl 80 provides working engagement and interaction of the gear teeth 70-2 and the pawl 80. For example, the pawl 80 includes first and second socket hub engagement portions 81 disposed on opposing sides of the axel 88 and in proximity to the opposing levers 86. As illustrated in FIG. 6, the first socket hub engagement portion 81-1 is configured as a first tooth 83-1 while the second socket hub engagement portion 81-2 is configured as a second tooth 83-2. Each of the first and second teeth 83-1, 83-2 are configured to selectively engage a notch 71 defined between two adjacent internal teeth 70-2 on the socket hub 14, 16 as shown in FIG. 5 and as will be described below.

As indicated above, and as illustrated in FIG. 4, the spring mechanism 82 can be configured as a ball 85 and a spring 87 disposed within a chamber 100 defined by the support member 26. The spring 87 provides compression load on the ball 85 to force ball 85 against the spring mechanism engagement portion 90 of the pawl 80.

In one arrangement, the pawl 80 and spring mechanism 82 provide each socket hub 14, 16 with the ability to operate reversibly which, in turn, provides a user with the ability to change driving rotation of socket hub 14, 16 based upon the position of the shifter 18, 20. For example, the shifter 18, 20 allows user to toggle the driving direction of each socket hub 14, 16 between a clockwise driving direction, as shown in FIG. 4, to counter clockwise driving direction.

For example, with continued reference to FIG. 4 and additional reference to FIG. 6, with the position of the rotational direction controller 18, 20 as shown, a notch 71 defined between two adjacent teeth 70 on the socket hub 14 engages the second socket hub engagement portion 81-2 (e.g., tooth 83-2) associated with the pawl 80. The spring mechanism engagement portion 90 engages the ball 85 to lock the rotational position of the pawl 80 and to lock the rotational position of the socket hub 14. Accordingly, clockwise rotation of handle 12 allows user to tighten a corresponding fastener. Additionally, with position of the pawl 80 as shown, and with counterclockwise rotation of the handle 12, the socket hub 14 remains substantially rotationally stationary. With counterclockwise rotation of the handle 12, the pawl 80 rotates about the axel 88 and compresses the ball 85 against the spring 87 mechanism. This allows the second socket hub engagement portion 81-2 of the pawl 80 to rotate past the teeth 70 on the socket hub 14 until the handle 12 reaches some ending position. To reverse operation of the socket hub 14 (i.e., to loosen the fastener), the user actuates the lever 86 on the pawl 80 to rotate the pawl counterclockwise until engagement portion 102 engages the ball 85 and until a notch defined between two adjacent teeth on the socket hub 14 engages the first socket hub engagement portion 81-1 (e.g., tooth 83-1).

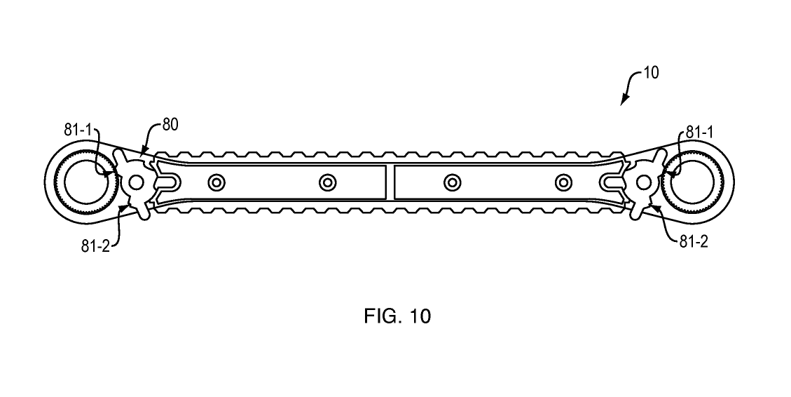

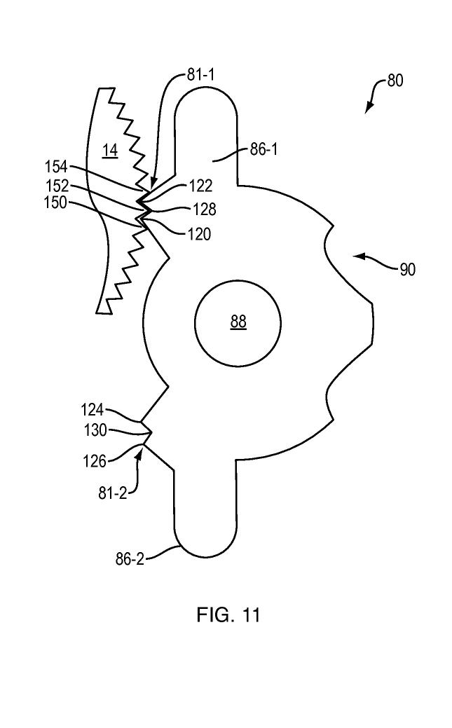

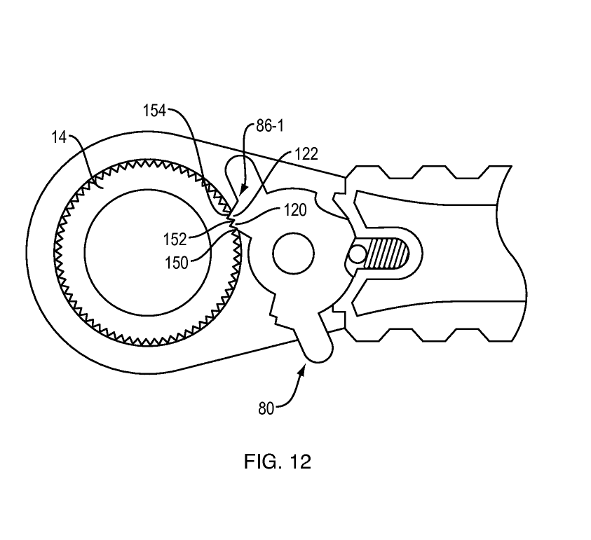

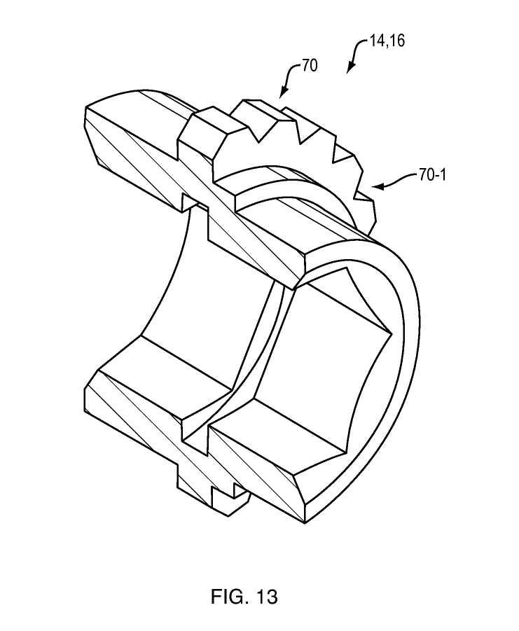

While FIGS. 4 and 6 illustrate the pawl 80 as having a first socket hub engagement portion 81-1 configured as a single first tooth 83-1 and a second socket hub engagement portion 81-2 configured as a single second tooth 83-2, such illustration is by way of example only. In one arrangement, as indicated in FIGS. 10 and 11, each of the first and second socket hub engagement portions 81-1, 81-2 is configured as having multiple teeth.

For example, with reference to FIG. 11, the ratchet wrench 10 includes an arrangement of the pawl 80 where the first socket hub engagement portion 81-1 includes a first tooth 120 and a second tooth 122 which define a gap 128 there between. Also, the second socket hub engagement portion 81-2 includes a first tooth 124 and a second tooth 126 which define a gap 130 as well. With this configuration, each of the first and second socket hub engagement portions 81-1, 81-2 is configured to engage three teeth of a corresponding socket hub 14, 16 during operation.

For example, as illustrated in FIG. 11 with reference to the first socket hub engagement portion 86-1, the first tooth 120 and the second tooth 122 mesh with consecutive first, second, and third internal teeth 150, 152, 154 of the socket hub 14. By engaging multiple teeth 150, 152, 154 on the socket hub 14, the socket hub engagement portion 86-1 distributes the shear area under load across the multiple teeth 120, thereby minimizing possible shear-induced damage to the pawl 80. Additionally, with multiple teeth 120, 122, the socket hub engagement portion 86-1 reduces the throw angle needed for the engagement of subsequent teeth on the socket hub 14. By reducing the throw angle, the socket hub engagement portion allows the ratchet wrench 10 to be used in relatively tight areas where a user has minimal room to advance the socket hub 14 relative to the pawl 80.

As indicated above, the teeth 70 of the socket hubs 14, 16 can be configured in a variety of ways. For example, in the arrangement illustrated in FIGS. 13 through 16, the teeth 70 are configured as external teeth 70-1 (i.e., as a gear) where the outer tooth diameter of each of the teeth is greater than either of the outside diameters of either of the hub extension portions 60, 62 of each of the socket hubs 14, 16.

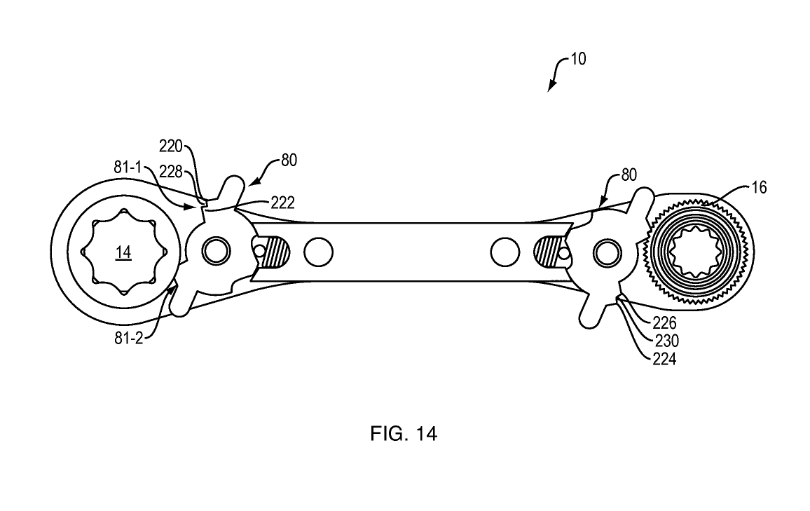

In the case where the teeth 70 are configured as external teeth 70-1, in order for the ratchet wrench 10 to provide a user with an increased toque capability and a decreased backlash, as indicated in FIG. 14, the external teeth 70-1 are configured to engage with a pawl 80 having multi-toothed first and second socket hub engagement portions 81-1, 81-2.

For example, with continued reference to FIG. 14, the ratchet wrench 10 includes an arrangement of the pawl 80 where the first socket hub engagement portion 81-1 includes a first tooth 220 and a second tooth 222 which define a gap 228 there between. Also, the second socket hub engagement portion 81-2 includes a first tooth 224 and a second tooth 126 which define a gap 130 there between as well. With this configuration, each of the first and second socket hub engagement portions 81-1, 81-2 is configured to engage three external teeth of a corresponding socket hub 14, 16 during operation.

While various embodiments of the innovation have been particularly shown and described, it will be understood by those skilled in the art that various changes in form and details may be made therein without departing from the spirit and scope of the innovation as defined by the appended claims.

For example, as described above, the first and second socket hubs 14, 16 can be sized to 1¼ Hex, 1⅛ Hex and 1 1/16 Hex, 15/16 Hex, respectively. Such description is by way of example only. In one arrangement, the first and second socket hubs 14, 16 can be configured with a variety of sizes. For example, the first and second socket hubs 14, 16 can be sized to ¾″ Hex, ⅞″ Hex and 15/16″ Hex, 1 1/16″ Hex, respectively, to provide a smaller opening sized tool. In another arrangement, the first and second socket hubs 14, 16 can be sized to 17 mm Hex, 19 mm Hex and 22 mm Hex, 24 mm Hex, respectively. In another arrangement, the first and second socket hubs 14, 16 can be sized to 17 mm Hex, 19 mm Hex and 24 mm Hex, 30 mm Hex, respectively.

In one arrangement, the socket hubs 14, 16 are provided with a visual indicator to provide easy identification by the user. For example, the socket hubs 14, 16 can be painted with high-visibility (e.g., Hi Vis) for easy identification.

As described above, FIG. 11 illustrates an alternate arrangement of the pawl 80 of FIGS. 4 and 7 where the pawl 80 includes first and second socket hub engagement portions 81-1, 81-2 having multiple teeth. Such description is by way of example, only. In one arrangement, any of the pawls 80 illustrated in FIGS. 8-10 can be configured with first and second socket hub engagement portions having multiple teeth.

What is claimed is:

1. A ratchet wrench, comprising:
a handle;
a first socket hub disposed at a first end of the handle, the first socket hub configured to actuate one of a first-sized fastener and a second-sized fastener and the first socket hub having a set of internal teeth disposed about an outer periphery of the first socket hub, the outer tooth diameter of each of the internal teeth is configured as being less than or equal to an outside diameter of the first socket hub;
a second socket hub disposed at a second end of the handle, the second end opposing the first end, the second socket hub configured to actuate one of a third-sized fastener and a fourth-sized fastener and the second socket hub having a set of internal teeth disposed about an outer periphery of the second socket hub, the outer tooth diameter of each of the internal teeth is configured as being less than or equal to an outside diameter of the second socket hub;
a first rotational direction controller having a pawl and spring mechanism, the pawl of the first rotational direction controller configured to engage at least one of the internal teeth of the first socket hub, the first rotational direction controller configured to allow one of clockwise and counterclockwise ratcheting of the first socket hub relative to the handle; and
a second rotational direction controller having a pawl and spring mechanism, the pawl of the second rotational direction controller configured to engage at least one of the internal teeth of the second socket hub, the second rotational direction controller configured to allow one of clockwise and counterclockwise ratcheting of the second socket hub relative to the handle.

2. The ratchet wrench of claim 1, wherein:
the first socket hub defines an opening extending along a longitudinal axis between a first end of the first socket hub and a second end of the first socket hub; and
the second socket hub defines an opening extending along a longitudinal axis between a first end of the second socket hub and a second end of the second socket hub.

3. The ratchet wrench of claim 1, wherein:
the first socket hub defines a first drive portion and a second drive portion, the second drive portion opposing the first drive portion, the first drive portion configured to actuate the first-sized fastener and the second drive portion configured to actuate the second-sized fastener; and
the second socket hub defines a third drive portion and a fourth drive portion, the third drive portion opposing the fourth drive portion, the third drive portion configured to actuate the third-sized fastener and the fourth drive portion configured to actuate the fourth-sized fastener.

4. The ratchet wrench of claim 3, wherein:
the first socket hub comprises a first hub extension portion extending from a first plate of the handle and a second hub extension portion extending from a second plate of the handle, the first plate opposing the second plate, the first hub extension portion disposed about the first drive portion and the second hub extension portion disposed about the second drive portion; and
the second socket hub comprises a first hub extension portion extending from the first plate of the handle and a second hub extension portion extending from the second plate of the handle, the first plate opposing the second plate, the first hub extension portion disposed about the third drive portion and the second hub extension portion disposed about the fourth drive portion.

5. The ratchet wrench of claim 1, wherein at least one of first socket hub and second socket hubs are removeably coupled to the handle.

6. The ratchet wrench of claim 5, wherein:
the first socket hub is rotatably disposed in a first opening defined by the handle, a longitudinal axis of the first opening being substantially collinear with a longitudinal axis of the first socket hub, the first socket hub defining a first groove portion and a first shoulder portion;
a first fixation mechanism disposed within the first groove portion, the first fixation mechanism and the first shoulder portion configured to capture the handle there between;
the second socket hub is rotatably disposed in a second opening defined by the handle, a longitudinal axis of the second opening being substantially collinear with a longitudinal axis of the second socket hub, the second socket hub defining a second groove portion and a second shoulder portion; and
a second fixation mechanism disposed within the second groove portion, the second fixation mechanism and the second shoulder portion configured to capture the handle there between.

7. The ratchet wrench of claim 1, wherein:
the pawl of the first rotational direction controller is configured with one tooth to engage at least one of the internal teeth of the first socket hub; and
the pawl of the second rotational direction controller is configured with one tooth to engage at least one of the internal teeth of the second socket hub.

8. The ratchet wrench of claim 1, wherein:
the pawl of the first rotational direction controller is configured with at least two teeth to engage at least one of the internal teeth of the first socket hub; and
the pawl of the second rotational direction controller is configured with at least two teeth to engage at least one of the internal teeth of the second socket hub.

9. The ratchet wrench of claim 1, wherein the handle comprises a serrated gripping surface.

10. A ratchet wrench, comprising:
a handle;
a first socket hub disposed at a first end of the handle, the first socket hub configured to actuate one of a first-sized fastener and a second-sized fastener and the first socket hub having a set of teeth disposed about an outer periphery of the first socket hub;
a second socket hub disposed at a second end of the handle, the second end opposing the first end, the second socket hub configured to actuate one of a third-sized fastener and a fourth-sized fastener and the second socket hub having a set of teeth disposed about an outer periphery of the second socket hub;
a first rotational direction controller having a pawl and spring mechanism, the pawl of the first rotational direction controller being configured with at least two teeth to engage at least three teeth of the set of teeth of the first socket hub, the first rotational direction controller configured to allow one of clockwise and counterclockwise ratcheting of the first socket hub relative to the handle; and
a second rotational direction controller having a pawl and spring mechanism, the pawl of the second rotational direction controller being configured with at least two teeth to engage at least three teeth of the set of teeth of the second socket hub, the second rotational direction controller configured to allow one of clockwise and counterclockwise ratcheting of the second socket hub relative to the handle.

11. The ratchet wrench of claim 10, wherein:
the first socket hub defines an opening extending along a longitudinal axis between a first end of the first socket hub and a second end of the first socket hub; and
the second socket hub defines an opening extending along a longitudinal axis between a first end of the second socket hub and a second end of the second socket hub.

12. The ratchet wrench of claim 10, wherein:
the first socket hub defines a first drive portion and a second drive portion, the second drive portion opposing the first drive portion, the first drive portion configured to actuate the first-sized fastener and the second drive portion configured to actuate the second-sized fastener; and
the second socket hub defines a third drive portion and a fourth drive portion, the third drive portion opposing the fourth drive portion, the third drive portion configured to actuate the third-sized fastener and the fourth drive portion configured to actuate the fourth-sized fastener.

13. The ratchet wrench of claim 12, wherein:
the first socket hub comprises a first hub extension portion extending from a first plate of the handle and a second hub extension portion extending from a second plate of the handle, the first plate opposing the second plate, the first hub extension portion disposed about the first drive portion and the second hub extension portion disposed about the second drive portion; and
the second socket hub comprises a first hub extension portion extending from the first plate of the handle and a second hub extension portion extending from the second plate of the handle, the first plate opposing the second plate, the first hub extension portion disposed about the third drive portion and the second hub extension portion disposed about the fourth drive portion.

14. The ratchet wrench of claim 10, wherein at least one of first socket hub and second socket hubs are removeably coupled to the handle.

15. The ratchet wrench of claim 14, wherein:
the first socket hub is rotatably disposed in a first opening defined by the handle, a longitudinal axis of the first opening being substantially collinear with a longitudinal axis of the first socket hub, the first socket hub defining a first groove portion and a first shoulder portion;
a first fixation mechanism disposed within the first groove portion, the first fixation mechanism and the first shoulder portion configured to capture the handle there between;
the second socket hub is rotatably disposed in a second opening defined by the handle, a longitudinal axis of the second opening being substantially collinear with a longitudinal axis of the second socket hub, the second socket hub defining a second groove portion and a second shoulder portion; and
a second fixation mechanism disposed within the second groove portion, the second fixation mechanism and the second shoulder portion configured to capture the handle there between.

16. The ratchet wrench of claim 10, wherein:
the first socket hub comprises a set of internal teeth disposed about an outer periphery of the first socket hub, the outer tooth diameter of each of the internal teeth is configured as being less than or equal to an outside diameter of the first socket hub; and
the second socket hub comprises a set of internal teeth disposed about an outer periphery of the second socket hub, the outer tooth diameter of each of the internal teeth is configured as being less than or equal to an outside diameter of the second socket hub.

17. The ratchet wrench of claim 10, wherein:
the first socket hub comprises a set of external teeth disposed about an outer periphery of the first socket hub, the outer tooth diameter of each of the external teeth is configured as being greater than an outside diameter of the first socket hub; and
the second socket hub comprises a set of external teeth disposed about an outer periphery of the second socket hub, the outer tooth diameter of each of the external teeth is configured as being greater than an outside diameter of the first socket hub.

18. The ratchet wrench of claim 1, wherein the handle comprises a serrated gripping surface.

19. A ratchet wrench, comprising:
a handle defining a length of at least 8 inches;
a first socket hub disposed at a first end of the handle, the first socket hub configured to actuate one of a first-sized fastener having a minimum size of ¾ inches Hex and a second-sized fastener having a minimum size of ¾ inches Hex and the first socket hub having a set of teeth disposed about an outer periphery of the first socket hub;
a second socket hub disposed at a second end of the handle, the second end opposing the first end, the second socket hub configured to actuate one of a third-sized fastener having a minimum size of ¾ inches Hex and a fourth-sized fastener having a minimum size of ¾ inches Hex and the second socket hub having a set of teeth disposed about an outer periphery of the second socket hub;
a first rotational direction controller having a pawl and spring mechanism, the pawl of the first rotational direction controller being configured to engage the teeth of the first socket hub, the first rotational direction controller configured to allow one of clockwise and counterclockwise ratcheting of the first socket hub relative to the handle; and
a second rotational direction controller having a pawl and spring mechanism, the pawl of the second rotational direction controller being configured to engage at least the teeth of the second socket hub, the second rotational direction controller configured to allow one of clockwise and counterclockwise ratcheting of the second socket hub relative to the handle.

20. The ratchet wrench of claim 19, wherein:
the first socket hub comprises a set of internal teeth disposed about the outer periphery of the first socket hub, the pawl of the first directional controller being configured with at least one tooth to engage at least two teeth of the first socket hub; and
the second socket hub comprises a set of internal teeth disposed about the outer periphery of the second socket hub, the pawl of the second directional controller being configured with at least one tooth to engage at least two teeth of the second socket hub.

21. The ratchet wrench of claim 19, wherein:
the first socket hub comprises one of a set of internal teeth and external teeth disposed about the outer periphery of the first socket hub, the pawl of the first directional controller being configured with at least two teeth to engage at least three teeth of the first socket hub; and
the second socket hub comprises one of a set of internal teeth and external teeth disposed about the outer periphery of the second socket hub, the pawl of the second directional controller being configured with at least two teeth to engage at least three teeth of the second socket hub.
